(19) United States
(12) Patent Application Publication
(10) Pub. No.: US 2025/0309284 A1
(43) Pub. Date: Oct. 2, 2025

(54) FUEL CELL STACK

(71) Applicant: Honda Motor Co., Ltd., Tokyo (JP)

(72) Inventors: Fumiya Arai, Saitama (JP); Naoki Tanaka, Saitama (JP); Tomoya Fujii, Saitama (JP)

(21) Appl. No.: 19/062,022

(22) Filed: Feb. 25, 2025

(30) Foreign Application Priority Data
Mar. 29, 2024 (JP) 2024-055707

(51) Int. Cl. H01M 8/0267; H01M 8/0252; H01M 8/2418

(52) U.S. Cl. CPC H01M 8/0267; H01M 8/0252; H01M 8/2418

(57) ABSTRACT

A fuel cell stack including a cell stacked body, first and second end units, a cooling medium discharge flow path, and a tube arranged in the cooling medium discharge flow path. The second end unit includes a first end surface facing the cooling medium discharge flow path and a second end surface opposite to the first end surface, a through-hole is formed penetrating the second end unit to communicate with a second opening of the tube on downstream side of the cooling medium discharge flow path, the first and second end units include first and second support portions supporting peripheral portions of the first and second ends of the tube, the second support portion includes a tapered portion formed on an inner peripheral surface of the through-hole, and the tapered portion is formed to gradually narrow toward the second end surface of the second end unit.

### CROSS-REFERENCE TO RELATED APPLICATION

This application is based upon and claims the benefit of priority from Japanese Patent Application No. 2024-055707 filed on Mar. 29, 2024, the content of which is incorporated herein by reference.

### BACKGROUND OF THE INVENTION

### Field of the Invention

This invention relates to a fuel cell stack.

### Description of the Related Art

In recent years, technological developments have been made on a fuel cell that contribute to energy efficiency in order to ensure access to energy that is affordable, reliable, sustainable and advanced by more people. As a conventional technology relates to this type of a fuel cell, there is a known technology in which a resin-made air vent passage is placed inside a cooling medium discharge manifold to discharge bubbles within the cooling medium discharge manifold to the outside through the air vent passage. Such an technology is described, for example, in FIG. 8 in Japanese Unexamined Patent Publication No. 2019-079779 (JP 2019-079779 A). JP 2019-079779 A states that the air vent passage is joined or fixed to the inner surface of the cooling medium discharge manifold within the cooling medium discharge manifold.

However, it is difficult to stably support the air vent passage within the cooling medium discharge manifold where cooling medium flows, without interfering with components such as an end unit.

### SUMMARY OF THE INVENTION

An aspect of the present invention is a fuel cell stack including: a cell stacked body including a plurality of power generation cells stacked in a predetermined direction, each of the plurality of power generation cells including a membrane electrode structure and a separator; a first end unit and a second end unit disposed at one end and another end of the cell stacked body in the predetermined direction, respectively; a cooling medium discharge flow path provided penetrating the cell stacked body in the predetermined direction to discharge a cooling medium supplied to the plurality of power generation cells; and a tube arranged in the cooling medium discharge flow path and formed in a substantially cylindrical shape, a first opening communicating with an upstream side of the cooling medium discharge flow path being provided at a first end of the tube, a second opening communicating with a downstream side of the cooling medium discharge flow path being provided at a second end of the tube. The second end unit includes a first end surface facing the cooling medium discharge flow path and a second end surface opposite to the first end surface, a through-hole is formed penetrating the second end unit to communicate with the second opening of the tube, the first end unit and the second end unit include a first support portion supporting a peripheral portion of the first end of the tube and a second support portion supporting a peripheral portion of the second end of the tube, respectively, the second support portion includes a tapered portion formed on an inner peripheral surface of the through-hole and extending along an axial line substantially parallel to the predetermined direction, and the tapered portion is formed to gradually narrow toward the second end surface of the second end unit.

### BRIEF DESCRIPTION OF THE DRAWINGS

The objects, features, and advantages of the present invention will become clearer from the following description of embodiments in relation to the attached drawings, in which:

FIG. 1 is a perspective view schematically showing an overall configuration of a fuel cell stack according to an embodiment of the present invention;

FIG. 2 is a perspective view showing a schematic configuration of a unitized electrode assembly included in the fuel cell stack of FIG. 1;

FIG. 3 is a rear view of the fuel cell stack in FIG. 1;

FIG. 4 is a cross-sectional view taken along line IV-IV in FIG. 3;

FIG. 5 is an enlarged view of a V part in FIG. 4;

FIG. 6 is a cross-sectional view taken along line IV-IV in FIG. 3;

FIG. 7 is an enlarged view of a VII part in FIG. 4;

FIG. 8 is a view showing another example of a rear support portion supporting a rear end of a communication tube;

FIG. 9 is a view when viewed in an arrow IX direction of FIG. 8; and

FIG. 10 is a view showing a modification of FIG. 9.

### DETAILED DESCRIPTION OF THE INVENTION

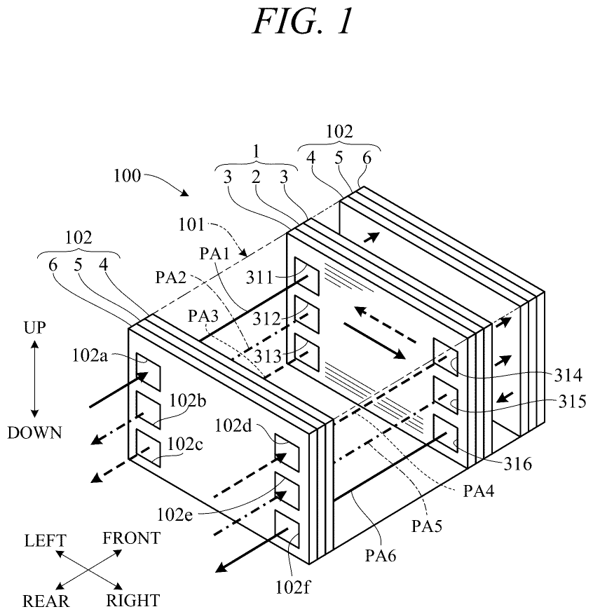

Hereinafter, an embodiment of the present invention will be described with reference to FIGS. 1 to 10. A fuel cell stack according to an embodiment of the present invention is a main component of a fuel cell. The fuel cell is mounted on, for example, a vehicle and can generate electric power for driving the vehicle. First, an overall configuration of the fuel cell stack will be schematically described.

FIG. 1 is a perspective view schematically showing an overall configuration of a fuel cell stack 100 according to the embodiment of the present invention. Hereinafter, for the sake of convenience, three-axis directions orthogonal to each other as illustrated in the drawing are defined as a front-rear direction, a left-right direction, and an up-down direction, and a configuration of each part will be described according to such definitions. The downward direction in the up-down direction corresponds to a gravity direction, or substantially gravity direction. The front-rear direction corresponds to the stacking direction of the fuel cell stack 100. The front-rear direction and left-right direction are not necessarily the same as the front-rear direction and left-right direction of the vehicle.

As shown in FIG. 1, the fuel cell stack 100 has a cell stacked body 101 formed by stacking a plurality of power generation cells 1 in the front-rear direction, and end units 102 arranged at both ends in the front-rear direction of the cell stacked body 101, and the whole of the fuel cell stack 100 has a substantially rectangular parallelepiped shape. Although not shown, the periphery of the cell stacked body 101 is covered by a substantially rectangular parallelepiped-shaped case. The length of the cell stacked body 101 in the left-right direction is longer than its length in the up-down direction. For convenience, a single power generation cell 1 is shown in FIG. 1.

The power generation cell 1 has a unitized electrode assembly (hereinafter, referred to as a “UEA”) 2 including a joint body (a membrane electrode assembly) that includes an electrolyte membrane and electrodes, and separators 3 and 3 arranged on both sides in the front-rear direction of the UEA 2 to sandwich the UEA 2. The UEA 2 and the separator 3 are alternately arranged in the front-rear direction. The UEA 2 can also be referred to as a membrane electrode structure, a membrane electrode unit, or a membrane electrode member.

The separator 3 has a pair of front and rear plates, which are metal thin plates with a corrugated cross-section. The front and rear plates are integrally configured by being joined by welding or the like at their outer peripheral edges. The separator 3 uses a conductive material with excellent corrosion resistance, such as stainless steel, titanium, or titanium alloy. Inside the separator 3 (between the pair of thin plates), a cooling flow path through which a cooling medium flows is formed. The generating surface of the power generation cell 1 is cooled by the flow of the cooling medium. Water, for example, can be used as the cooling medium. The surface of the separator 3 (front surface and rear surface) facing the UEA 2 is formed into an uneven shape by press molding or the like to form a gas flow path between the membrane electrode assembly of the UEA 2 and the separator 3.

The separator 3 on the front side of the UEA 2 is a separator (anode separator) on an anode side, for example. Between the anode separator 3 and the membrane electrode assembly of the UEA 2, an anode flow path through which fuel gas (anode gas) flows is formed. The separator 3 on the rear side of the UEA 2 is a separator (cathode separator) on a cathode side, for example. Between the cathode separator 3 and the membrane electrode assembly of the UEA 2, a cathode flow path through which oxidant gas (cathode gas) flows is formed. The fuel gas is a gas containing hydrogen, and hydrogen gas can be used, for example. The oxidant gas is a gas containing oxygen, and air can be used, for example. The fuel gas and the oxidant gas may collectively be referred to as a reaction gas without distinguishing between them.

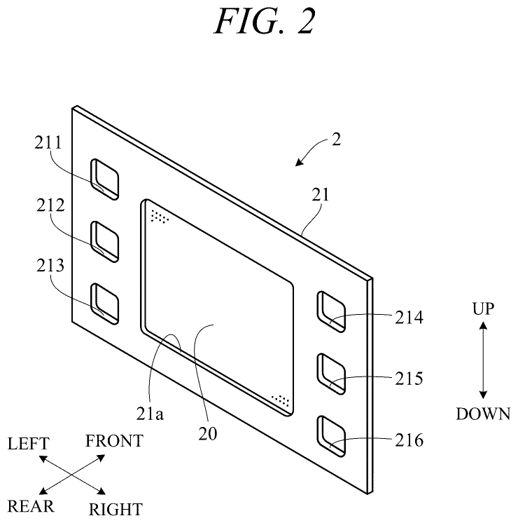

FIG. 2 is a perspective view showing a schematic configuration of the UEA 2. As shown in FIG. 2, the UEA 2 includes a substantially rectangular membrane electrode assembly (hereinafter, referred to as a “MEA”) 20 and a frame 21 that supports the MEA 20. The MEA 20 has an electrolyte membrane, an anode electrode provided on a front surface of the electrolyte membrane, and a cathode electrode provided on a rear surface of the electrolyte membrane.

The electrolyte membrane is, for example, a solid polymer electrolyte membrane, and a thin film of perfluorosulfonic acid polymer containing moisture can be used. Not only a fluorine-based electrolyte but also a hydrocarbon-based electrolyte can be used.

The anode electrode has an electrode catalyst layer formed on the front surface of the electrolyte membrane and served as a reaction field for electrode reaction, and a gas diffusion layer formed on the front surface of the electrode catalyst layer to spread and supply the fuel gas. The cathode electrode has an electrode catalyst layer formed on the rear surface of the electrolyte membrane and served as a reaction field for electrode reaction, and a gas diffusion layer formed on the rear surface of the electrode catalyst layer to spread and supply the oxidant gas. The electrode catalyst layers include a catalyst metal that promotes the electrochemical reaction of hydrogen contained in the fuel gas and oxygen contained in the oxidant gas, an electrolyte (such as an ionomer) with proton conductivity, and carbon particles with electron conductivity, and the like. The gas diffusion layers are made of conductive members with gas permeability, such as carbon porous bodies.

In the anode electrode, the fuel gas (hydrogen) supplied through the anode flow path the gas diffusion layer is ionized by an action of a catalyst, passes through the electrolyte membrane, and moves to the cathode electrode side. Electrons generated at this time pass through an external circuit and are extracted as electric energy. In the cathode electrode, an oxidant gas (oxygen) supplied via the cathode flow path and the gas diffusion layer reacts with hydrogen ions guided from the anode electrode and electrons moved from the anode electrode to generate water. The generated water gives an appropriate humidity to the electrolyte membrane, and excess water is discharged to an outside of the UEA 2 along the gas flow. The generated water on the cathode side also flows to the anode side by inverse spread through the electrolyte membrane. Therefore, the generated water is present in both the anode flow path and the cathode flow path. The frame 21 is a film-shaped member having a substantially rectangular shape, and is made of an insulating resin, rubber, or the like. A substantially rectangular opening 21a is provided in a central portion of the frame 21. The MEA 20 is disposed to cover the entire opening 21a and a peripheral portion of the MEA 20 is supported by the frame 21. Three through-holes 211 to 213 penetrating the frame 21 in the front-rear direction are opened side by side in the up-down direction on the left side of the opening 21a of the frame 21. Three through-holes 214 to 216 penetrating the frame 21 in the front-rear direction are opened side by side in the up-down direction on the right side of the opening 21a of the frame 21.

As shown in FIG. 1, in the separator 3 in front of and behind the UEA 2, through-holes 311 to 316 penetrating the separators 3 in the front-rear direction are opened at positions corresponding to the through-holes 211 to 216 of the frame 21. The through-holes 311 to 316 communicate with the through-holes 211 to 216 of the frame 21, respectively. The set of the through-holes 211 to 216 and 311 to 316 communicating with each other forms flow paths PA1 to PA6 (indicated by arrows for the sake of convenience) penetrating the cell stacked body 101 and extending in the front-rear direction. The flow paths PA1 to PA6 may be referred to as manifolds. The flow paths PA1 to PA6 are connected to a manifold outside the fuel cell stack 100.

The flow path PA1 (solid arrow) extending forward via the through-holes 211 and 311 is a fuel gas supply flow path. The flow path PA6 (solid arrow) extending rearward via the through-holes 216 and 316 is a fuel gas discharge flow path. The fuel gas supply flow path PA1 and the fuel gas discharge flow path PA6 communicate with the anode flow path facing the front surface of the MEA 20, and as indicated by the solid arrows, the fuel gas (anode gas) flows through the anode flow path from the left (upper left) to the right (lower right) via the fuel gas supply flow path PA1 and the fuel gas discharge flow path PA6. The communication between the anode flow path and the other flow paths PA2 to PA5 is blocked via a seal portion not shown.

The flow path PA4 (dotted arrow) extending forward via the through-holes 214 and 314 is an oxidant gas supply flow path. The flow path PA3 (dotted arrow) extending rearward via the through-holes 213 and 313 is an oxidant gas discharge flow path. The oxidant gas supply flow path PA4 and the oxidant gas discharge flow path PA3 communicate with the cathode flow path facing the rear surface of the MEA 20, and as indicated by the dotted arrows, the oxidant gas flows through the cathode flow path from the right (upper right) to the left (lower left) via the oxidant gas supply flow path PA4 and the oxidant gas discharge flow path PA3. The communication between the cathode flow path and the other flow paths PA1, PA2, PA5 and PA6 is blocked via a seal portion not shown.

The flow path PA5 (dashed-dotted arrow) extending forward via the through-holes 215 and 315 is a cooling medium supply flow path. The flow path PA2 (dashed-dotted arrow) extending rearward via the through-holes 212 and 312 is a cooling medium discharge flow path. The cooling medium supply flow path PA5 and the cooling medium discharge flow path PA2 communicate with the cooling flow path inside the separator 3, and the cooling medium flows from the right to the left through the cooling flow path via the cooling medium supply flow path PA5 and the cooling medium discharge flow path PA2. The communication between the cooling flow path and the other flow paths PA1, PA3, PA4 and PA6 is blocked via a seal portion not shown.

Each of the end units 102 disposed on both sides in the front-rear direction of the cell stacked body 101 includes a terminal plate 4, an insulating plate 5, and an end plate 6. The front end unit 102 is sometimes called a dry side end unit, and the rear end unit 102 is sometimes called a wet side end unit. The pair of terminal plates 4 and 4 are arranged on both sides in the front-rear direction sandwiching the cell stacked body 101. The pair of insulating plates 5 and 5 are arranged on both sides in the front-rear direction sandwiching the terminal plates 4 and 4. The pair of end plates 6 and 6 are arranged on both sides in the front-rear direction sandwiching the insulating plates 5 and 5.

The terminal plate 4 is a substantially rectangular plate-shaped member made of metal, and has a terminal portion for extracting electric power generated by an electrochemical reaction in the cell stacked body 101. The insulating plate 5 is a substantially rectangular plate-shaped member made of non-conductive resin or rubber, and electrically insulates the terminal plate 4 from the end plate 6. The end plate 6 is a plate-shaped member made of metal or resin having high strength. To the cell stacked body, a compressive load is applied in the front-rear direction during the assembly of the fuel cell stack 100, and in this state, the case surrounding the cell stacked body 101 and the front and rear end units 102 are fastened. Therefore, after the assembly of the fuel cell stack 100 is completed, the compressive load on the fuel cell stack 100 is maintained.

A plurality of through-holes 102a to 102f that penetrate the end unit 102 in the front-rear direction are opened in the rear end unit 102. Although the through-holes 102a to 102f each includes a through-hole penetrating the terminal plate 4, a through-hole penetrating the insulating plate 5, and a through-hole penetrating the end plate 6, but in FIG. 1, these are collectively shown as through-holes 102a to 102f for convenience.

The through-hole 102a is opened on the extension line of the fuel gas supply flow path PA1 so as to communicate with the fuel gas supply flow path PA1. The through-hole 102b is opened on the extension line of the cooling medium discharge flow path PA2 so as to communicate with the cooling medium discharge flow path PA2. The through-hole 102c is opened on the extension line of the oxidant gas discharge flow path PA3 so as to communicate with the oxidant gas discharge flow path PA3. The through-hole 102d is opened on the extension line of the oxidant gas supply flow path PA4 so as to communicate with the oxidant gas supply flow path PA4. The through-hole 102e is opened on the extension line of the cooling medium supply flow path PAS so as to communicate with the cooling medium supply flow path PA5. The through-hole 102f is opened on the extension line of the fuel gas discharge flow path PA6 so as to communicate with the fuel gas discharge flow path PA6.

Among the through-holes 102a to 102f, especially, to the through-hole 102e, a pump for supplying cooling medium is connected, and the cooling medium is supplied to the fuel cell stack 100 through the through-hole 102e. The cooling medium is discharged from the through-hole 102b. The discharged cooling medium is cooled by heat exchange in the radiator, and is supplied again to the fuel cell stack 100 through the through-hole 102e.

The above is the schematic configuration of the fuel cell stack 100. The fuel cell stack 100 is accommodated in a substantially box-shaped case, and is mounted on the vehicle.

In such a fuel cell stack 100, after the fuel cell stack 100 is assembled, a cooling medium is injected into the fuel cell stack 100 through the through-hole 102e. In this situation, the air in the cooling flow path moves to the cooling medium discharge flow path PA2 along the flow of the cooling medium while moving upward. In addition, when the air is mixed in the cooling medium supplied through the through-hole 102e, the air also moves to the cooling medium discharge flow path PA2 along the flow of the cooling medium. For this reason, the air (air bubbles) easily stays in an upper area of the cooling medium discharge flow path PA2, and the air that stays has to be discharged from the cooling medium discharge flow path PA2. The present embodiment has a characteristic in the configuration for discharging the air that stays in the cooling medium discharge flow path PA2. Hereinafter, this configuration will be described.

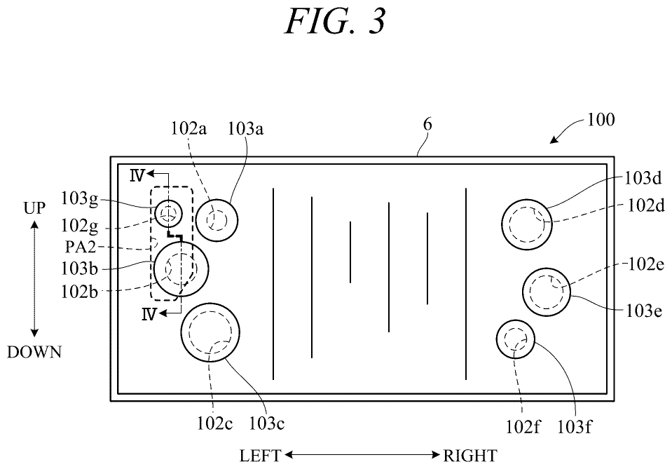

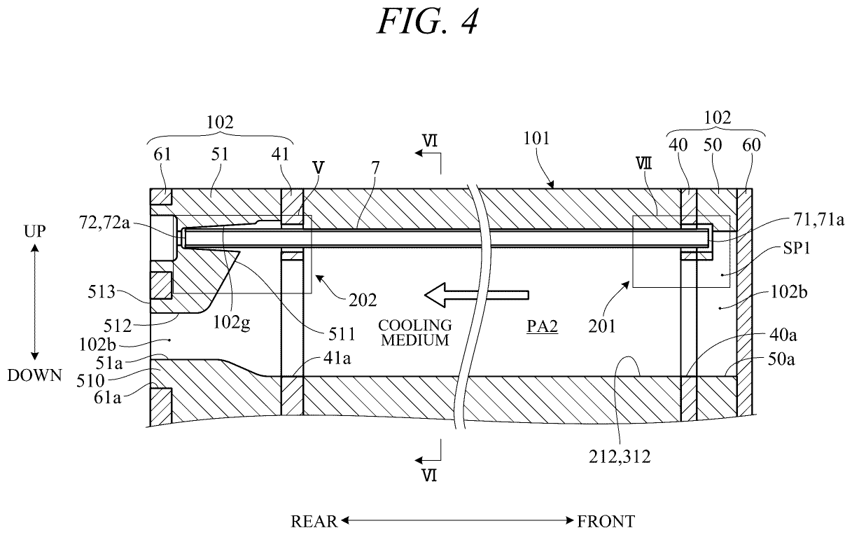

FIG. 3 is a rear view of the fuel cell stack 100, and FIG. 4 is a cross-sectional view taken along line IV-IV of FIG. 3. In FIG. 3, the shape of the rear surface of the wet side end plate 6 (arrangements of the through-holes 102a to 102f, and the like) is illustrated more specifically. In FIG. 4, individual illustration of the power generation cells 1 of the cell stacked body 101 is omitted. Further, in FIGS. 3 and 4, in order to distinguish between the configurations of the end units 102 on the front side and the rear side, the end unit 102 on the front side (dry side) is represented by a terminal plate 40, an insulating plate 50, and an end plate 60, and the end unit 102 on the rear side (wet side) is represented by a terminal plate 41, an insulating plate 51, and an end plate 61.

As illustrated in FIG. 4, the cooling medium discharge flow path PA2 extends in the front-rear direction through the through-hole 102b of the front end unit 102, the through-holes 212 and 312 of the cell stacked body 101, and the through-hole 102b of the rear end unit 102. The through-hole 102b of the front end unit 102 includes a through-hole 40a of the terminal plate 40 and a through-hole 50a of the insulating plate 50. The front end of the cooling medium discharge flow path PA2 is closed by the end plate 60.

The through-hole 102b of the rear end unit 102 includes a through-hole 41a of the terminal plate 41, a through-hole 51a of the insulating plate 51, and a through-hole 61a of the end plate 61. More specifically, a protruding portion 510, which protrudes rearward, is provided on the insulating plate 51, and the protruding portion 510 is fit into the through-hole 61a of the end plate 61. Therefore, the through-hole 51a is provided inside the through-hole 61a.

FIG. 3 illustrates piping attachment portions 103a to 103f, to which external piping to communicate with the through-holes 102a to 102f of the rear end unit 102, are attached. As illustrated in FIG. 3, the piping attachment portions 103e and 103b for supplying and discharging the cooling medium are respectively located on outer sides in the left-right direction than the piping attachment portions 103a and 103d for supplying the fuel gas and supplying the oxidizer gas, and are respectively located on outer sides in the left-right direction than the piping attachment portions 103f and 103c for discharging the fuel gas and discharging the oxidizer gas.

In the end unit 102, a through-hole 102g for discharging the air is open on an obliquely upper left side of the through-hole 102b for discharging the cooling medium. The through-hole 102g will be referred to as a first through-hole, and the through-hole 102b will be referred to as a second through-hole, in some cases. A piping attachment portion 103g is attached to the through-hole 102g. The through-hole 102g communicates with external piping for discharging the air via the piping attachment portion 103g. In FIG. 3, the cooling medium discharge flow path PA2 of the cell stacked body 101 is indicated by a dotted line. The through-holes 102b and 102g are both provided inside the cooling medium discharge flow path PA2. More specifically, the through-hole 102b is located in a lower portion of the cooling medium discharge flow path PA2, and the through-hole 102g is located in an uppermost portion of the cooling medium discharge flow path PA2.

As illustrated in FIG. 4, the through-hole 102b and the through-hole 102g are branched from the cooling medium discharge flow path PA2, and are respectively provided on the insulating plate 51. The circumferential edge of the through-hole 102b includes: a tapered surface 511 (a reduced diameter portion) formed in a tapered shape such that the opening area gradually decreases toward the rear; and a cylindrical surface 512 extending rearward from a rear end portion of the tapered surface 511 to an outlet of a rear end of the through-hole 102b (a rear end surface 513 of the insulating plate 51). The through-hole 102g extends rearward from the tapered surface 511, and penetrates the insulating plate 51 in the front-rear direction. The through-hole (the first through-hole) 102g is smaller in diameter than the through-hole 102b (the second through-hole), that is, the cylindrical surface 512.

In the cooling medium discharge flow path PA2, a communication tube 7 is installed along a flow path upper surface. The communication tube 7 is an elongated tube member having a substantially cylindrical cross-section, and openings (a front end opening 71a and a rear end opening 72a) are respectively provided on a front end surface 71 and a rear end surface 72. The communication tube 7 extends linearly in the front-rear direction along the cooling medium discharge flow path PA2. The front end portion and the rear end portion of the communication tube 7 respectively protrude forward and rearward from the cell stacked body 101.

The communication tube 7 is made of resin, rubber, glass, or the like as a component material. However, in consideration of vibrations and temperature changes that occur in the fuel cell stack 100, the communication tube 7 is preferably made of resin or rubber having flexibility. The air (air bubbles) staying in an upper portion of the cooling medium discharge flow path PA2 passes through the inside of the communication tube 7. The cross-sectional area of the communication tube 7 is sufficiently smaller than the cross-sectional area of the cooling medium discharge flow path PA2.

The front end opening 71a of the communication tube 7 is located in an internal space SP1 of the through-hole 102b of the front end unit 102. More specifically, the through-hole 40a of the terminal plate 40 and the through-hole 50a of the insulating plate 50 have substantially the same shapes as the cooling medium discharge flow path PA2 when viewed from the front-rear direction, and the front end opening 71a passes through the through-hole 40a, and is located inside the through-hole 50a. Accordingly, the front end opening 71a communicates with the cooling medium discharge flow path PA2 via the internal space SP1. Instead of the through-hole 50a, a recessed portion may be provided on the rear surface of the insulating plate 50, the front end opening 71a may be located inside the recessed portion, and the front end opening 71a may also communicate with the cooling medium discharge flow path PA2 via an inner space of the recessed portion.

A rear end portion of the communication tube 7 is fit into the through-hole 102g of the insulating plate 51, and the rear end opening 72a communicates with the through-hole 102g. Thus, the internal space SP1 of the front end unit 102 and the through-hole 102g of the rear end unit 102 communicate with each other through the communication tube 7.

The internal space SP1 is a space on an upstream side of the cooling medium discharge flow path PA2, and the pressure of the internal space SP1 on the upstream side of the flow of the cooling medium is larger than the pressure inside the through-hole 102g. Accordingly, a pressure difference is generated between the front end opening 71a and the rear end opening 72a of the communication tube 7, and air bubbles move in the communication tube 7 from the front end opening 71a to the rear end opening 72a in accordance with the pressure difference. By providing the communication tube 7 having a long size from the front end unit 102 to the rear end unit 102 in the cooling medium discharge flow path PA2 in this manner, the pressure difference between both end portions of the communication tube 7 increases, so that the movement of the air bubbles can be promoted.

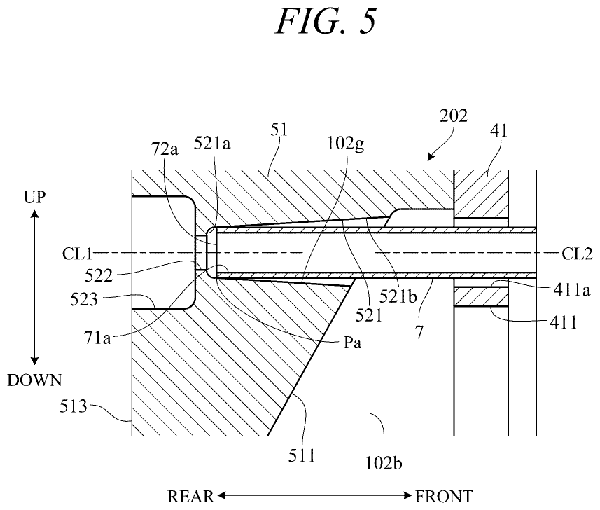

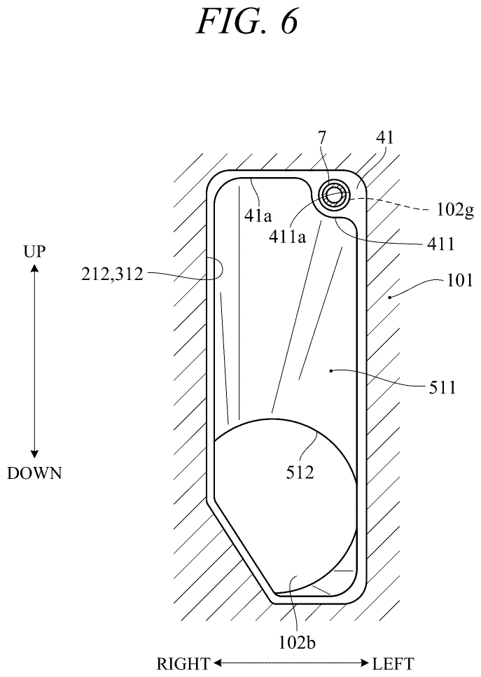

The front end portion of the communication tube 7 is supported by a front support portion 201, which is provided in the front end unit 102, and the rear end portion of the communication tube 7 is supported by a rear support portion 202, which is provided in the rear end unit 102. FIG. 5 is an enlarged view of a main part of FIG. 4 (an enlarged view of a V part in FIG. 4), illustrating a configuration of the rear support portion 202, and FIG. 6 is a cross-sectional view taken along line VI-VI of FIG. 4. As illustrated in FIGS. 5 and 6, the terminal plate 41 includes a protruding portion 411, which protrudes to the inside of the through-hole 41a, and is located at a left upper corner portion of a circumferential edge of the through-hole 41a (FIG. 4). A through-hole 411a having a substantially circular shape is open on the protruding portion 411, and the rear end portion of the communication tube 7 is inserted into the through-hole 411a.

The through-hole 102g is provided to be centered on an axis CL1 extending in the front-rear direction. The through-hole 102g includes: a tapered portion 521, which includes a tapered surface 521b formed in a tapered shape to be centered on the axis CL1 so that an opening area gradually decreases toward the rear; a small diameter portion 522, which has a substantially cylindrical shape to be centered on the axis CL1, which is continuous with a rear end portion 521a of the tapered portion 521, and which has an opening area smaller than that of the rear end portion 521a; and a large diameter portion 523, which has a substantially cylindrical shape, which is continuous with the small diameter portion 522, and which has an opening area larger than that of the small diameter portion 522. The small diameter portion 522 and the tapered portion 521 is connected in a step-shaped manner, and the small diameter portion 522 and the large diameter portion 523 is connected in a step-shaped manner.

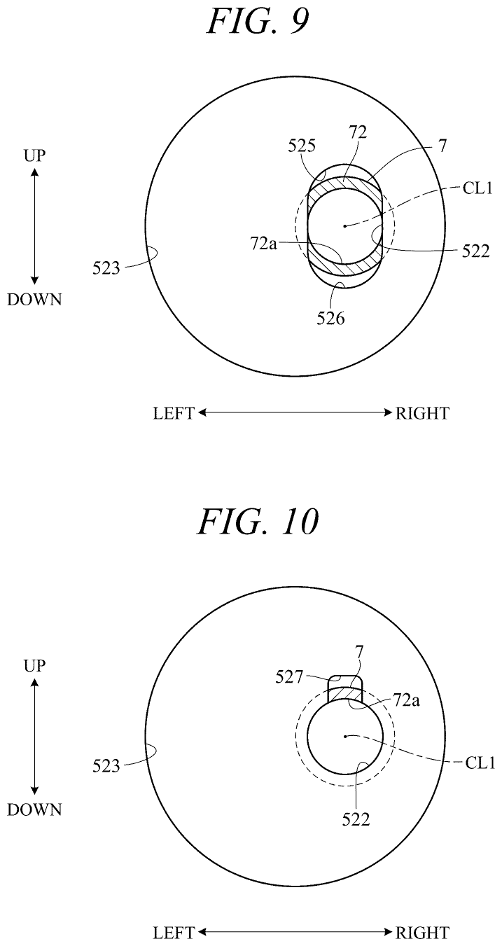

External piping is connected to the large diameter portion 523 via the piping attachment portion 103g (FIG. 3). A tip end portion of the external piping is fit into, for example, the large diameter portion 523, and the external piping is attached to the piping attachment portion 103g with the shaft sealed. The opening area of the large diameter portion 523 is larger than the opening area of the rear end portion 521a of the tapered portion 521. In order to avoid interference between pieces of the external piping, the center of the large diameter portion 523 (the center of the piping attachment portion 103g in FIG. 3) is shifted from the axis CL1 (see FIG. 9). The center of the large diameter portion 523 may be aligned with the axis CL1, unless there is a possibility of the interference between pieces of the external piping.

The rear end surface 72 of the communication tube 7, more specifically, the outer circumferential edge of the rear end surface 72 abuts the tapered portion 521 (the tapered surface 521b) over the entire circumference. For example, the rear end surface 72 abuts the tapered portion 521 on a front side relative to the rear end portion 521a of the tapered portion. Accordingly, the axis CL1 of the through-hole 102g coincides with a center line CL2 of the communication tube 7, so that the position of the rear end opening 72a of the communication tube 7 can be defined with accuracy.

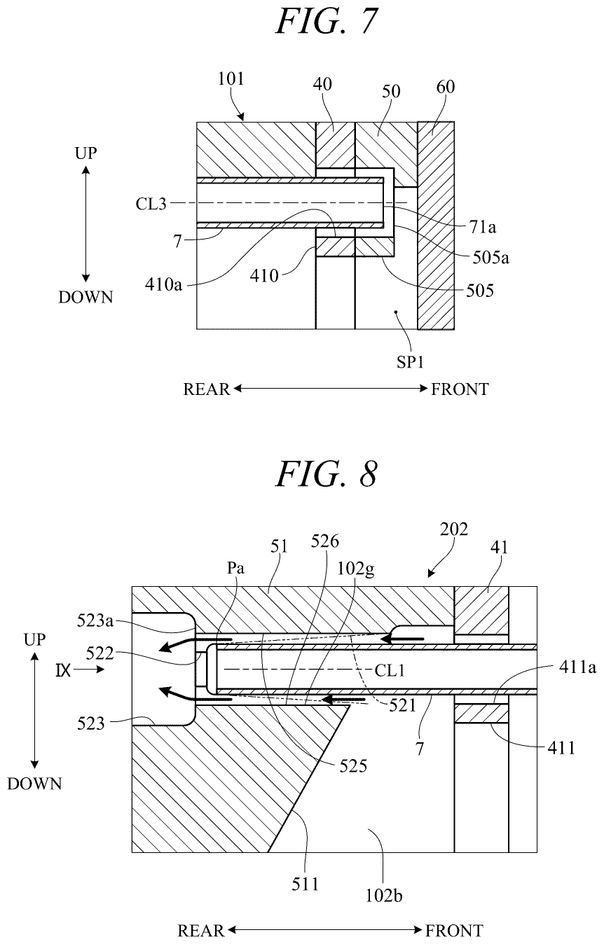

FIG. 7 is an enlarged view of a main part of FIG. 4 (an enlarged view of a VII part), illustrating a configuration of the front support portion 201. As illustrated in FIG. 7, the front support portion 201 is configured similarly to the rear support portion 202. That is, the terminal plate 40 includes a protruding portion 410, which protrudes to the inside of the through-hole 40a. A through-hole 410a having a substantially circular shape is open on the protruding portion 410, and the front end portion of the communication tube 7 is inserted into the through-hole 410a. A holder 505, which has a substantially cylindrical shape to be centered on an axis CL3 located on an extension line of the axis CL1 (FIG. 5), is provided in an upper end portion of a circumferential edge of the through-hole 50a of the insulating plate 50. The outer circumferential surface of the front end portion of the communication tube 7 is supported by the holder 505.

An opening portion 505a having a substantially circular shape is provided on a front wall of the holder 505, and the front end opening 71a and the internal space SP1 communicate with each other through the opening portion 505a. A cutout may be provided in a lower portion of the holder 505 so that the front end opening 71a communicates with the internal space SP1 through such a cutout. The inner circumferential surface of the holder 505 may be formed in a tapered shape similarly to the rear support portion 202, instead of the cylindrical surface.

In this manner, in the present embodiment, the rear end portion and the front end portion of the communication tube 7 are supported via the rear support portion 202 of the end unit 102 including the tapered portion 521, which tapers toward the rear side, and the front support portion 201 of the end unit 102 including the holder 505 having a substantially cylindrical shape. Accordingly, it becomes possible to hold the communication tube 7 in a predetermined position in an upper end portion of the cooling medium discharge flow path PA2 in a stable state. As a result, the position of the front end opening 71a with respect to the opening portion 505a is restricted, so that the air bubbles can be satisfactorily introduced into the communication tube 7 through the opening portion 505a. In addition, the position of the rear end opening 72a with respect to the through-hole 102g is restricted, so that the air bubbles that have passed through the communication tube 7 can be satisfactorily discharged to the outside through the through-hole 102g.

In the configuration of FIG. 5, by the way, the outer circumferential edge of the rear end portion of the communication tube 7 abuts the circumferential surface (the tapered surface 521b) of the tapered portion 521 in an abutment position Pa over the entire circumference. Accordingly, there is no gap between the through-hole 102g and the communication tube 7 in the abutment position Pa. Therefore, when air bubbles are generated around the rear end portion of the communication tube 7 (for example, inside the through-hole 102b) along the flow of the cooling medium, it is difficult to discharge the air bubbles to the outside through the communication tube 7 because the distance from the air bubbles to the front end opening 71a of the communication tube 7 is long. In consideration of this, the rear support portion 202 is preferably configured as illustrated in FIG. 8. FIG. 8 is an enlarged view of a main part of FIG. 4, illustrating another example of the rear support portion 202, and FIG. 9 is a view when viewed in an arrow IX direction of FIG. 8.

FIG. 8 is different from FIG. 5 in the configuration of the through-hole 102g, particularly the configuration of the tapered portion 521. That is, as illustrated in FIGS. 8 and 9, groove portions 525 and 526, each of which has a slit shape to be recessed from the tapered surface 521b, and which penetrate part of the small diameter portion 522 and extend in the front-rear direction substantially parallel to the axis CL1, are provided in an upper end portion and a lower end portion of the tapered portion 521. A bottom surface (an upper end surface) of the groove portion 525 on an upper side is located to be lower than an upper end surface of the large diameter portion 523. A bottom surface (a lower end surface) of the groove portion 526 on a lower side is located to be higher than a lower end surface of the large diameter portion 523.

The groove portions 525 and 526 each have a predetermined width in the left-right direction, and extend from the tapered surface 511 to a front end surface 523a of the large diameter portion 523 beyond the abutment position Pa of the rear end portion of the communication tube 7. The positions of the bottom surfaces of the groove portions 525 and 526, that is, the position of the upper end surface of the groove portion 525 and the position of the lower end surface of the groove portion 526 are constant in the front-rear direction. The cross-sectional shape of the through-hole 102g in a range from the tapered surface 511 to the front end surface 523a of the large diameter portion 523 is, for example, an oval shape as illustrated in FIG. 9. Therefore, at the rear end portion of the communication tube 7, both end portions in the left-right direction abut the tapered portion 521, and the rear end surface 72 is exposed at the upper and lower rear end portions (illustrated by hatching, for convenience).

This generates a gap between the communication tube 7 and the through-hole 102g from the through-hole 102b on the front side of the tapered surface 511 to an inner space of the large diameter portion 523 on the rear side of the communication tube 7. Therefore, the flows of the air as indicated by arrows in FIG. 8 are enabled, so that the air bubbles can be moved rearward through the gaps (the groove portions 525 and 526). As a result, even through the air bubbles are generated around the rear end portion of the communication tube 7 along the flow of the cooling medium, the air bubbles can be satisfactorily discharged to the outside of the fuel cell stack 100 through the through-hole 102g.

The cross-sectional shape of the through-hole 102g is not limited to the oval shape, and may be an elliptical shape elongated in the up-down direction. The air bubbles stay in an upper portion of the cooling medium discharge flow path PA2. Therefore, instead of providing the groove portions 525 and 526 respectively in the upper end portion and the lower end portion of the tapered portion 521, for example, as illustrated in FIG. 10, a groove portion 527 may be provided only in the upper end portion. In FIG. 10, the width of the groove portion 527 is smaller than the diameter of the small diameter portion 522. The width of the groove portion 527 may be identical to the width of the small diameter portion 522, or may be larger than the width of the small diameter portion 522.

According to the present embodiment, the following operations and effects are achievable.
(1) The fuel cell stack 100 includes: the cell stacked body 101, which is configured by stacking the plurality of power generation cells 1 each including the UEA 2 and the separator 3 in the front-rear direction; the front and rear end units 102 and 102, which are respectively disposed in the front end portion and the rear end portion of the cell stacked body 101; the cooling medium discharge flow path PA2, which is provided to penetrate through the cell stacked body 101 in the front-rear direction to discharge the cooling medium that has been guided to the plurality of power generation cells 1; and the communication tube 7, which has a substantially cylindrical shape, which is disposed in the cooling medium discharge flow path PA2, and which include the front end opening 71a and the rear end opening 72a respectively provided on the front end portion and the rear end portion and respectively communicating with the upstream side and the downstream side of the cooling medium discharge flow path PA2 (FIGS. 1, 2, and 4). The rear end unit 102 includes the front end surface (tapered surface 511) facing the cooling medium discharge flow path PA2 and the rear end surface 513 (FIG. 4). The through-hole 102g, which communicates with the rear end opening 72a of the communication tube 7, and which penetrates the rear end unit 102, is open on the rear end unit 102 (FIG. 4). The front and rear end units 102 and 102 respectively include the front support portion 201 and the rear support portion 202, which respectively support the circumferential edge portion of the front end portion and the circumferential edge portion of the rear end portion of the communication tube 7. The rear support portion 202 includes, on the circumferential surface of the through-hole 102g, the tapered portion 521 including the tapered surface 521b, which is formed to narrow toward the outlet of the through-hole 102g (the rear end surface 513 of the end unit 102) and to be centered on the axis CL1 extending substantially parallel to the front-rear direction (FIG. 5).

In this manner, by supporting the front end portion of the communication tube 7 on a front side of the cell stacked body 101 and the rear end portion of the communication tube 7 on a rear side of the cell stacked body 101 via the front support portion 201 provided in the front end unit 102 and the rear support portion 202 provided in the rear end unit 102, and also supporting the front end portion via the tapered portion 521, the communication tube 7 can be positioned with accuracy and held in the cooling medium discharge flow path PA2. Accordingly, when a compression load is applied in the stacking direction of the power generation cells 1 at the time of assembling the fuel cell stack 100 to compress the cell stacked body 101, the end unit 102 and the communication tube 7 do not interfere with each other, and the communication tube 7 can be stably held in the upper end portion of the cooling medium discharge flow path PA2 where the flow of the cooling medium is generated.
(2) The tapered portion 521 includes the groove portions 525 to 527, which are recessed from the tapered surface 521b, and which extend substantially parallel to the axis CL1 beyond the abutment position Pa in abutment with the rear end of the communication tube 7 (FIGS. 8 to 10). When the rear end of the communication tube 7 abuts the tapered portion 521, the gap between the communication tube 7 and the through-hole 102g is closed, and air bubbles may stay around the rear end portion of the communication tube 7. In this regard, by providing the groove portions 525 to 527 in the tapered portion 521, the flow of the air to the rear side beyond the abutment position Pa is enabled via the groove portions 525 to 527. Accordingly, the air bubbles staying in the cooling medium discharge flow path PA2 can be discharged satisfactorily.
(3) The communication tube 7 extends in a substantially horizontal direction (FIG. 4). The groove portions 525 and 527 are provided in an upper portion of the tapered portion 521 (FIGS. 9 and 10). The air bubbles stay in the upper portion of the cooling medium discharge flow path PA2. However, the provision of the groove portions 525 and 527 in the upper portion enables only the air bubbles to be efficiently discharged through the groove portions 525 and 527.
(4) The rear end unit 102 includes: the terminal plate 41, which is disposed to be adjacent to the cell stacked body 101; the insulating plate 51, which is disposed to be adjacent to the terminal plate 41; and the end plate 61, which is disposed to be adjacent to the insulating plate 51 (FIG. 4). The tapered portion 521 is provided on the insulating plate 51 (FIGS. 5 and 8). This enables the tapered portion 521 to be easily formed together with the groove portions 525 to 527.

The above embodiments can be modified into various forms. Hereinafter, some modifications will be described. In the above embodiment, the dry side end unit 102 (a first end unit) is configured by the terminal plate 40, the insulating plate 50, and the end plate 60 and the wet side end unit 102 (a second end unit) is configured by the terminal plate 41, the insulating plate 51, and the end plate 61. However, the configurations of the first end unit and the second end unit are not limited to those described above. The tapered portion 521 may be provided on a member other than the insulating plate 51.

In the above embodiment, the communication tube 7, which has the front end opening 71a (a first opening) at the front end (a first end) and the rear end opening 72a (a second opening) at the rear end (a second end) communicating with the upstream and downstream sides of the cooling medium discharge flow path PA2, respectively, is arranged at the top of the cooling medium discharge flow path PA2. However, the configuration of a tube formed in a substantially cylindrical shape is not limited to the above. In the above embodiment, the communication tube 7 is arranged to extend in a substantially horizontal direction, that is, in a substantially horizontal posture. However, the posture of the tube is not limited to a substantially horizontal posture. In the above embodiment, the plurality of power generation cells 1 are stacked in the front-rear direction (predetermined direction) to form the cell stacked body 101. However, the predetermined direction may be other than the front-rear direction.

In the above embodiment, the front support portion 201 (a first support portion) and the rear support portion 202 (a second support portion) support the periphery of the front end of the communication tube 7 on the front side of the cell stacked body 101 (a periphery portion of the first end) and the periphery of the rear end of the communication tube 7 on the rear side of the cell stacked body 101 (a periphery portion of the second end), respectively. However, the configuration of a first support portion is not limited to the above. Also, as long as a tapered portion is formed to narrow toward the outlet of the through hole 102g (an end surface on the outer side of the end unit) centered on the axis CL1 extending in the stacking direction of the power generation cells 1, the configuration of a second support portion may take any configuration. In the above embodiment, the groove portions 525 and 526 are formed continuously with the upper and lower ends of the small diameter portion 522 of the through-hole 102g. However, as long as it extends substantially parallel to the axis CL1 beyond the abutment position Pa where the tip of the communication tube 7 abuts, the configuration of a groove portion may take any form.

The above embodiment can be combined as desired with one or more of the above modifications. The modifications can also be combined with one another.

According to the present invention, it is possible to stably support an air vent tube in a cooling medium discharge flow path without interfering with components such as an end unit.

Above, while the present invention has been described with reference to the preferred embodiments thereof, it will be understood, by those skilled in the art, that various changes and modifications may be made thereto without departing from the scope of the appended claims.

What is claimed is:

1. A fuel cell stack comprising:
a cell stacked body including a plurality of power generation cells stacked in a predetermined direction, each of the plurality of power generation cells including a membrane electrode structure and a separator;
a first end unit and a second end unit disposed at one end and another end of the cell stacked body in the predetermined direction, respectively;
a cooling medium discharge flow path provided penetrating the cell stacked body in the predetermined direction to discharge a cooling medium supplied to the plurality of power generation cells; and
a tube arranged in the cooling medium discharge flow path and formed in a substantially cylindrical shape, a first opening communicating with an upstream side of the cooling medium discharge flow path being provided at a first end of the tube, a second opening communicating with a downstream side of the cooling medium discharge flow path being provided at a second end of the tube, wherein
the second end unit includes a first end surface facing the cooling medium discharge flow path and a second end surface opposite to the first end surface,
a through-hole is formed penetrating the second end unit to communicate with the second opening of the tube,
the first end unit and the second end unit include a first support portion supporting a peripheral portion of the first end of the tube and a second support portion supporting a peripheral portion of the second end of the tube, respectively,
the second support portion includes a tapered portion formed on an inner peripheral surface of the through-hole and extending along an axial line substantially parallel to the predetermined direction, and
the tapered portion is formed to gradually narrow toward the second end surface of the second end unit.

2. The fuel cell stack according to claim 1, wherein
the tapered portion includes a groove portion provided to extend substantially parallel to the axial line toward the second end surface beyond a contact position where an end of the tube contacts the inner peripheral surface of the through-hole.

3. The fuel cell stack according to claim 2, wherein
the tube is provided to extend in a substantially horizontal direction, and
the groove portion is provided in an upper portion of the tapered portion.

4. The fuel cell stack according to claim 1, wherein
the second end unit includes a terminal plate disposed adjacent to the cell stacked body, an insulating plate disposed adjacent to the terminal plate, and an end plate disposed adjacent to the insulating plate, and
the tapered portion is formed in the insulating plate.

5. The fuel cell stack according to claim 1, wherein
the through-hole is a first through-hole, and
a second through-hole is provided below the first through-hole in the second end unit to form the cooling medium discharge flow path.

6. The fuel cell stack according to claim 5, wherein
the first through-hole is smaller than the second through-hole and is provided to branch from the cooling medium discharge flow path.

7. The fuel cell stack according to claim 6, wherein
the second end unit includes a reduced diameter portion formed to gradually decrease a flow path area toward the second through-hole, and
the first through hole is configured to extend through the second end unit from an upper end portion of the reduced diameter portion to the second end surface of the second end unit.

8. The fuel cell stack according to claim 4, wherein
the insulating plate includes a protrusion portion protruding toward the end plate, and
the protruding portion is fitted into a through-hole provided in the end plate.
